(19) United States
(12) Patent Application Publication
(10) Pub. No.: US 2023/0329157 A1
(43) Pub. Date: Oct. 19, 2023

(54) WATER AND ENERGY EFFICIENT AGRICULTURE HABITAT SYSTEM

(71) Applicant: Wanjun Gao, Weston, FL (US)

(72) Inventor: Wanjun Gao, Weston, FL (US)

(21) Appl. No.: 18/025,479

(22) PCT Filed: Sep. 14, 2021
(86) PCT No.: PCT/US2021/050307

§ 371 Date: Mar. 9, 2023

Related U.S. Application Data
(60) Provisional application No. 63/080,705, filed on Sep. 19, 2020.
(60) Provisional application No. 63/078,282, filed on Sep. 14, 2020.

(51) Int. Cl. A01G 9/24; F24S 20/67; F24S 23/00

(52) U.S. Cl. CPC A01G 9/243; F24S 20/67; F24S 23/10

(57) ABSTRACT

A computer-controlled greenhouse system constructed in accordance with the invention above provides climate management and precision cultivation capability. It is equipped with solar energy filtering devices to precisely manage visible sunlight intake based on plants stages and adjust solar heat intake according to climate management needs; it uses geothermal energy for heating and cooling; it reclaims water from moisture released by plants with vapor condensing devices.

### CROSS-REFERENCE TO RELATED APPLICATIONS

This application claims the benefit of U.S. Provisional Application No. 63/078,282 filed on Sep. 14, 2020, the entire disclosure of which is hereby incorporated in its entirety. This application also claims the benefit of U.S. Provisional Application No. 63/080,705 filed on Sep. 19, 2020, the entire disclosure of which is hereby incorporated in its entirety..

### FIELD OF THE INVENTION

The disclosure relates generally to the field of agriculture; cultivation of vegetables, flowers, rice, fruit, vines, hops, or seaweed; forestry; and watering thereof. More specifically, this disclosure relates to devices or systems for heating, ventilating, regulating temperature, illuminating, or watering, in greenhouses, forcing-frames, or the like. Moreover, the disclosure also relates generally to the field of efficient electrical power generation; moreover, it relates to constructional details of greenhouses; and it is related to electric or magnetic, or acoustic treatment of plants for promoting growth with electric lighting.

### BACKGROUND OF THE INVENTION

Compared to outdoor farming, indoor farming provides greater control of plants’ habitat environment such as lighting, temperature, and humidity. It reduces the dependence of agriculture activities on weather and location, enables year-round cultivation, and reduces transportation costs.

However, with the development of technologies involving precision agriculture, more energies are used to power computer systems, robotic systems, artificial lighting devices, and HVAC systems. A large percentage of operating costs are energy-intensive and inefficient. Efficient usage of solar energy helps reduce operating costs and improve overall efficiency.

At the same time, with the increased usage of indoor farming, the usage of water also increases. Effective use of water is essential to make indoor farming a sustainable practice.

This invention provides energy & water efficient solutions for controlled habitats

### BRIEF SUMMARY OF THE INVENTION

A computer-controlled greenhouse system constructed in accordance with the invention above provides climate management and precision cultivation capability. It is equipped with solar energy filtering devices to precisely manage visible sunlight intake based on plants stages and adjust solar heat intake according to climate management needs; it uses geothermal energy for heating and cooling; it reclaims water from moisture released by plants with vapor condensing devices.

### BRIEF DESCRIPTION OF THE SEVERAL VIEWS OF THE DRAWINGS

The subject matter disclosed is illustrated through embodiments in the drawings:

FIG. 1A is a top plan view of an embodiment of energy & water efficient greenhouse;

FIGS. 1B-1E are the side elevation views of an embodiment of an energy & water efficient greenhouse:

FIG. 2 is an exploded view of an embodiment of an energy and water efficient greenhouse;

FIG. 3 is a schematic diagram of the mechanism of a light-filtering assembly of embodiments that separates, captures, and provides passages for solar energy based on wavelength; and

FIG. 4 is a block diagram of a light-filtering assembly with fiber optical wires in providing lighting for a multi-layer grow setup.

### DETAILED DESCRIPTION OF THE INVENTION

One embodiment of the invention illustrated is a computer-controlled greenhouse system designed to lower energy and water consumption.

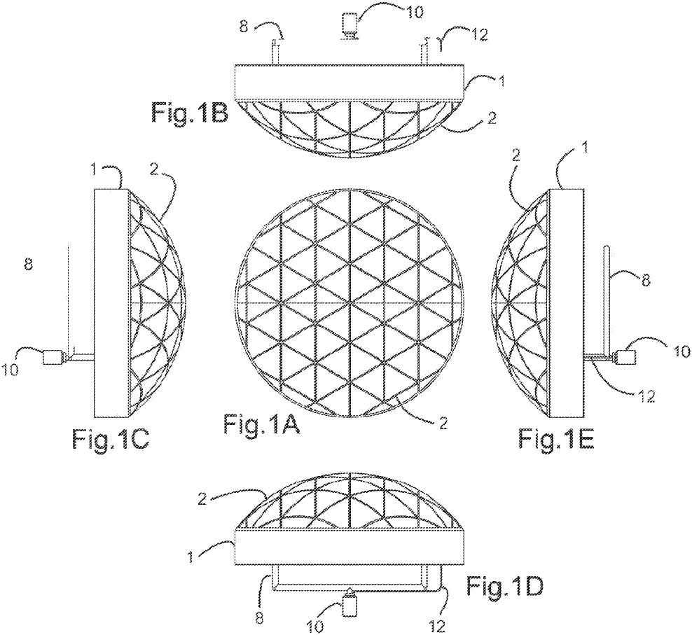

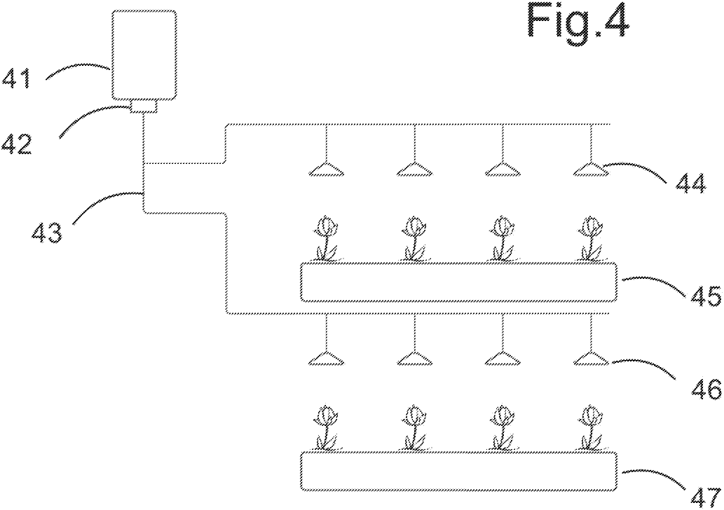

The main body 1 (FIG. 1D) and the members of the greenhouse below body 1, including tunnels 8 (FIG. 1D), water reservoir 10 (FIG. 1D), potion of plumbing system 12 (FIG. 1D) are constructed in-ground to reduce exposure to the surface environment. While roof 2 (FIG. 1D) is positioned above ground to receive sunlight.FIG. 4 is a block diagram of a light-filtering assembly with fiber optical wires in providing lighting for a multi-layer grow setup.

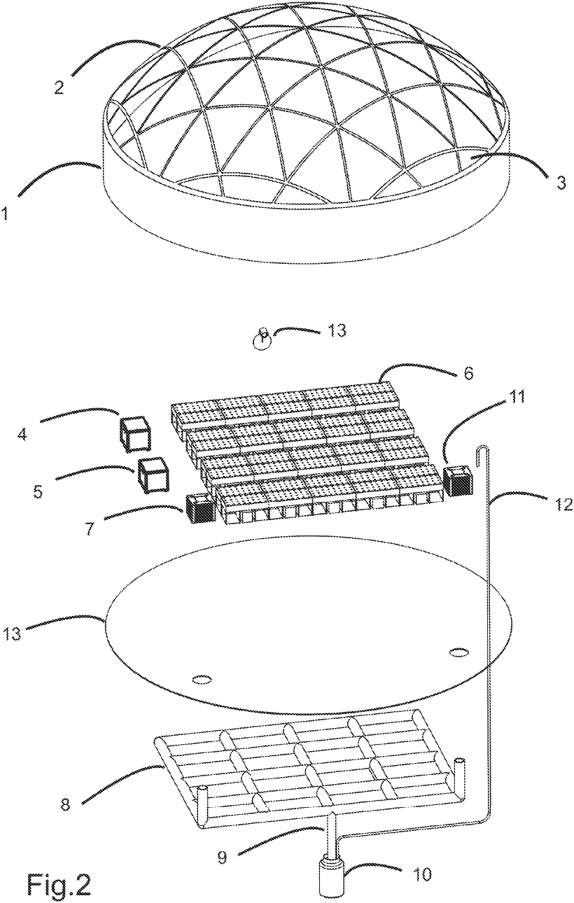

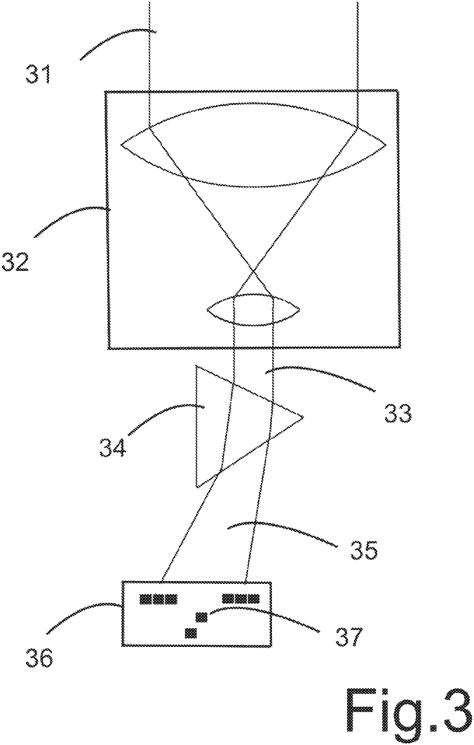

The roof 2 (FIG. 2) of the greenhouse comprises a plurality of optical solar cell panels 3 (FIG. 2) that uses a prism mechanism to allow passage of light of selected wavelengths suitable for plants’ photosynthesis process and also capture the remaining solar energy to generate electricity. The optical solar cell panels 3 (FIG. 2) comprise at least one light-filtering assembly in FIG. 3. The mechanism of the light-filtering assembly is explained in detail later in this description.

The electricity generated by the solar cell panels is stored in battery 4 (FIG. 2) located in the greenhouse. The battery 4 (FIG. 2) is an optional power source for a computing system 5 (FIG. 2) comprising a computing processor and a memory. The battery 4 (FIG. 2) and is also an optional power source for other usages, such as illumination

Plants are grown on aeroponics planters 6 (FIG. 2), each of which is a form of soilless grow device within which plant roots are suspended in midair. In each of the aeroponic planters 6 (FIG. 2), the nutrient liquid is sprayed in a form of fine mists and delivered to the suspended plant roots. The aeroponics planters are placed on the floor of said greenhouse.

An air conditioning means uses geothermal heating and cooling by funneling air through an air intaking device 7 (FIG. 2) into underground tunnels 8 (FIG. 2) located under the greenhouse’s floor 13 (FIG. 2), where the air temperature is stabilized through heat exchange with ground material outside the tunnels 8. The moisture released into the air by the plants during growth is captured by a water reclaiming means comprising a water reservoir 10 (FIG. 2) and a dehumidifying means comprising moisture condensing unit 9 (FIG. 2) and underground tunnels 8 (FIG. 2). The water is recycled as freshwater supply stored in said water reservoir 10 (FIG. 2), ready to be used and applied to the vegetation via plumbing system 12 (FIG. 2).

Then the air is released through an air venting device 11 (FIG. 2) back into the greenhouse to condition the air temperature of the greenhouse to a predetermined level.

In summary, the greenhouse system utilizes solar energy for photosynthesis and electricity generation. The reduction of surface exposure and the reduction of solar energy passing into the greenhouse help mitigate heat accumulation inside of the greenhouse. The passive geothermal heating and cooling method further reduces the energy consumption used to condition the air. Aeroponics planters use less water. In addition, the water vapor released by plants into the air during the growth is reclaimed and reused within the greenhouse, further minimizing the water consumption.

In addition, the greenhouse uses a computing system 5 (FIG. 2) to coordinate the sunlight intake, electricity generation, air conditioning schedule, and aeroponics nutrient and water delivery. The greenhouse equipment such as optical solar cell panels 3 (FIG. 2), air intaking device 7 (FIG. 2), the air venting device 11 (FIG. 2), the aeroponics planters 6 (FIG. 2), the moisture condensing unit 9 (FIG. 2), and the water reservoir 10 (FIG. 2) each includes computer interfaces for operatively communicating with computing system 5 (FIG. 2) for management purposes. One or more camera and environment telemetry sensing devices 13 (FIG. 2) are installed on the roof to monitor the environment and the plants growing inside of the greenhouse. The imaging and telemetrical data such as temperature, humidity, illumination is analyzed by the computing system 5 (FIG. 2) to provide reporting analysis, health state tracking, and event alerting functions for feedback control of temperature, watering, and the like.

The air intaking device 7 (FIG. 2) further attaches to an air pump, as an air pressurizing device, which increases the air pressure inside of the underground tunnel 8 (FIG. 2). Air compression operation heats up the air temperature inside tunnels 8 and produces an elevated temperature difference between two sides of the tunnel walls and speeds up the heat exchange between the air inside tunnels 8 and ground material outside of tunnels 8. The increased air pressure also helps to condense the air moisture.

The air venting device 11 (FIG. 2) attaches to a temperature sensor that assists the air temperature regulation and an air decompression device that reduces air pressure before release air back to the greenhouse. The decompressing process provides the further cooling capability to the air. The managed decompressing process with sensor feedbacks allows more accurate air conditioning control.

An embodiment of the mechanism of separating, capturing, and passing through solar energy is demonstrated by a light-filtering assembly in FIG. 3 where
Sunlight 31 (FIG. 3) reaches a light-concentrating device 32 (FIG. 3) where the light beam is concentrated into a smaller but brighter concentrated light beam 33 (FIG. 3);
The concentrated light beam 33 (FIG. 3) passes through a prism 34 (FIG. 3) and is split into a light spectrum 35 (FIG. 3) in respect to corresponding wavelengths;
The light spectrum travels further and reaches solar energy capturing device 36 (FIG. 3) in a form similar to a window with multi-layer blinders inside, where arrays of solar cells 37 (side view in FIG. 3) assembled as blinder plates are positioned to block, capture, and convert light energy of certain wavelengths. The remaining light in the light spectrum travels through said solar energy capturing device 36 (FIG. 3).

As a result, the sunlight is separated based on the wavelength, with a portion of the light being captured and the remaining portion of the light passing through.

Adjusting the positions of blinder plants of solar cells 37 (FIG. 3) will result in changes in the ratio between the solar energy being captured and the solar energy passing through.

In addition, computing processors and programs are added to automatically adjust for the optimal position of the light-filtering assembly and its components to allow the passage of an optimal amount of light and to maximize the energy conversion efficiency.

A practical embodiment is a greenhouse enclosure panel with a plurality of the above light-filtering assemblies embedded within. The positions of the light-filtering assemblies as well as the positions of internal components of the light-filtering assemblies are mechanically adjustable to control the ranges of the wavelength of the solar light passing through. Therefore, the greenhouse enclosure panel can provide controlled lighting for plants according to growth stages, sunlight positions, the timing of the photosynthesis cycle, and the energy needed to be captured.

A computing processor and a memory containing programs are used to perform the above adjustments automatically to increase the responsiveness and operation efficiency. Fiber optics wire cables are optionally attached to the light-filtering assemblies to guide the filtered lights in a managed way to the plants for precision lighting control purposes. It is especially useful for a multiple-layer vertical farming setup to ensure the lower-layer plants also receive adequate lighting. FIG. 4 illustrated a usage of a light-filtering assembly with fiber optical wires in providing lighting for a multi-layer grow setup. Fiber optical wires 43 (FIG. 4) are wrapped as a cable. An optical connector 42 (FIG. 4) is configured to connect a light-filtering assembly 41 (FIG. 4) as input and the first ends of fiber optical wires 43 (FIG. 4) as output to collect the filtered light waves coming out of the light-filtering assembly 41 (FIG. 4) and transmit the filtered light waves on to the connected first ends of a respective fiber optical wires 43 (FIG. 4). The light travels through fiber optical wires 43 (FIG. 4) to the second ends (the opposite end) of the respective fiber optic wires 43 (FIG. 4), which are attached to the respective lamps in respective rows, represented by lamp 44 and lamp 46 (FIG. 4). Each of the lamps optionally comprises at least one diffusing lens to disperse light onto plants growing on planters, represented by planter 45 and planter 47 (FIG. 4).

1. A method for capturing solar energy for use in supporting vegetation in a greenhouse, while allowing passage of light of selected wavelengths, the method comprising:
(a) providing a light concentrating device for producing a concentrated light beam from a source light;
(b) positioning said light concentrating device to receive sunlight as an input and to produce a concentrated light beam therefrom;
(c) providing a prism;
(d) positioning said prism to capture said concentrated light beam and produce a light beam formed as a spectrum of the concentrated light beam;
(e) providing a solar energy capturing device for capturing solar energy at predetermined positions in respect to light sources;
(f) configuring and using said solar energy capturing device to capture light at predetermined positions corresponding to light of a specific wavelength in the spectrum while allowing the remaining light in said spectrum to pass through.

2. The method of claim 1, further comprising:
(a) providing mechanical components for adjusting the positions of said light concentrating device, said prism, and said solar energy capturing device;
(b) mechanically adjusting the positions of said light concentrating device, said prism, and said solar energy capturing device with predetermined criteria, and in response to changes of direction of sunlight.

3. The method of claim 2, further comprising:
(a) providing a computing processor and a memory with instructions on adjusting the positions of said light concentrating device, said prism, and said solar energy capturing device;
(b) operating said computing process and said memory to control said mechanical components to adjust the positions of said light concentrating device, said prism, and said solar energy capturing device with predetermined criteria, and in response to changes of direction of sunlight.

4. The method of claim 1, wherein said solar energy capturing device comprises solar cells with adjustable positions.

5. The method of claim 4, further comprising:
(a) adjusting the position of said solar cells to control capturing and passage of light of predetermined wavelengths in said light spectrum.

6. The method of claim 5, further comprising:
(a) providing a computing processor and a memory with predetermined instructions on adjusting the position of said solar cells;
(b) providing mechanical components that respond to said instructions to adjust positions of said solar cells;
(c) executing said instructions on said computing processor with said memory to adjust positions of said solar cells to control capturing and passage of light of predetermined wavelengths in said light spectrum.

7. A system for capturing solar energy while allowing passage of light of selected wavelengths comprising, comprising:
a light concentrating device for producing a concentrated light beam from regular sunlight beam;
a prism;
a solar energy capturing device for capturing solar energy;
wherein said light concentrating device, said prism, and said solar energy capturing device are positioned so that sunlight passes through said light concentrating device and forms a concentrated light beam; said concentrated light beam passes through said prism and forms a light spectrum; said light spectrum reaches said solar energy capturing device, where portions of the light energy at predetermined positions are captured while the remaining light passes through.

8. The system of claim 7, further comprising mechanical components for adjusting the positions of said light concentrating device, said prism, and said solar energy capturing device.

9. The system of claim 8, further comprising a computing processor and a memory with instructions on adjusting the positions of said light concentrating device, said prism, and said solar energy capturing device.

10. The system of claim 7, wherein said solar energy capturing device further comprises solar cells with adjustable positions.

11. The system of claim 10, further comprises a computing processor and a memory with predetermined instructions on adjusting the position of said solar cells.

12. The system of claim 7, further connects to fiber optical wires to guide said remaining light that passes through.

13. A water and energy efficient agriculture habitat system, comprising:
a greenhouse, wherein the top of enclosure of said greenhouse comprises a plurality of optical solar cell panels that configured to divide sunlight based on wavelengths of light to enable a portion of sunlight passing through and capture the remaining portion of sunlight to generate electricity;
at least one planter located inside of said greenhouse, wherein said planter is configured to support at least one plant;
whereby said greenhouse enables a lightning condition for photosynthesis process with sunlight and generates electricity at the same time.

14. The system of claim 13, further comprising at least one battery where said electricity is stored.

15. The system of claim 13, further comprising a computing processor and a memory containing at least one program and data, wherein said computing processor uses said program and data to control the configuration of said optical solar cell panels.

16. The system of claim 13, wherein the main body of said greenhouse is constructed in-ground.

17. The system of claim 13, said planter is an aeroponics planter configured to support at least one plant with the roots of said plant suspended in midair and to generate nutrient mists toward said roots.

18. The system of claim 13, further comprising a water reclaiming means, which comprises a water reservoir, a plumbing system, and a dehumidifying means configured to condense moisture from the air of said greenhouse into water and collecting said water into said water reservoir.

19. The system of claim 13, further comprising an air temperature conditioning means, which comprises at least one tunnel constructed in-ground below said greenhouse’s floor, an air intaking device configured to take air inside of said greenhouse into said tunnel, and a venting device configured to release air from said tunnel, wherein heat exchange takes place between the air inside of said tunnel and ground material outside of said tunnel.

20. The system of claim 13, further comprising at least one camera, a plurality of telemetry sensors, one computing processor, and one memory containing a program and data, wherein said computing processor uses said program and data to analyze imaging and telemetric data taken by said camera and said telemetry sensors to monitor the growth status of plants grown in said planters.

21. The system of claim 13, wherein said planters are aeroponics planters configured to support a plurality of plants with roots suspended in midair and to generate nutrient mists toward said roots; and wherein said system further comprising:
a water reclaiming means, which comprises a water reservoir, a plumbing system, and a dehumidifying means configured to condense moisture in the air inside of said greenhouse into water and collecting said water into said water reservoir;
an air temperature conditioning means, which comprises at least one tunnel constructed in-ground below said greenhouse’s floor, an air intaking device configured to take air inside of said greenhouse into said tunnel, and a venting device configured to release air from said tunnel, wherein heat exchange takes place between the air inside of said tunnel and ground material outside of said tunnel;
a monitoring and control system, which comprises at least one camera, a plurality of telemetry sensors, a computing processor, and a memory containing at least one program and data, wherein computing processor uses said program and data to analyze imaging and telemetric data taken by said camera and said telemetry sensors to perform a combination of tasks in a list of:
monitoring the growth status of said plants grown in said planters,
monitoring the operation of said optical solar cell panels, said aeroponics planters, air temperature conditioning means, said water reclaiming means,
controlling the operation of said optical solar cell panels, said aeroponics planters, air temperature conditioning means, said water reclaiming means,
and sending event alerts;.

22. The system of claim 21, wherein said air temperature conditioning means further comprising an air pressurizing device attached to said air intaking device for increasing the air pressure in said tunnel.

23. The system of claim 22, wherein said air temperature conditioning means further comprising a temperature sensor and an air decompression device attached to said venting device for decompressing air and monitoring air temperature before releasing into the space of said greenhouse.
